(19) United States
(12) Patent Application Publication
(10) Pub. No.: US 2013/0013419 A1
(43) Pub. Date: Jan. 10, 2013

(54) APPLICATION EXECUTION APPARATUS, APPLICATION PROVIDING APPARATUS, AND APPLICATION DISTRIBUTION METHOD USING CHAINING OF APPLICATIONS

(75) Inventors: Jae-Cheol SIM, Daejeon-si (KR); Sun-Joong KIM, Daejeon-si (KR)

(73) Assignee: Electronics and Telecommunications Research Institute, Daejeon (KR)

(21) Appl. No.: 13/542,869

(22) Filed: Jul. 6, 2012

(30) Foreign Application Priority Data
Jul. 8, 2011 (KR) 10-2011-0067987
Jun. 27, 2012 (KR) 10-2012-0069291

(51) Int. Cl. G06Q 30/02; G06F 15/16

(52) U.S. Cl. 705/14.69; 709/223

(57) ABSTRACT

An application execution terminal, an application providing apparatus, and an application distributing method using linkage between applications are provided. The method for distributing the applications enables to establish a mutual consignment sales model for all applications by receiving recommendations for applications related to an application being currently executed in the application execution terminal, executing the recommended application in the application execution terminal, and sharing revenues generated from the related applications.

### CROSS-REFERENCE TO RELATED APPLICATION

This application claims the benefit under 35 U.S.C. §119(a) of Korean Patent Application Nos. 10-2011-0067987, filed on Jul. 8, 2011, and 10-2012-0069291, filed on Jun. 27, 2012, the entire disclosures of which are incorporated herein by references for all purposes.

### BACKGROUND

1. Field

The following description relates to application software and e-commerce technology, and more particularly to a technology for the use of an application.

2. Description of the Related Art

With the proliferation of terminals such as smartphones, various applications have been increasingly developed and widely used. An application providing apparatus enables transactions between application developer and users and provides tens of thousands of applications registered therein to the users for a charge or free of charge. In addition, a diversity of smart home appliances, such as a smart TV, can execute the applications.

Generally, a user installs several to hundreds of applications for use in one terminal. Consequently, the user may have a trouble to find and execute a desired application amongst all the applications installed in the user's terminal. Moreover, it has been difficult for the users to search for an appropriate application among the millions of applications in the application providing apparatus as the number of applications registered is increasing.

Once an application is sold to one user, the application developer cannot derive additional revenue from the same user, and thus it is difficult to ensure the profitability. As a result, most application developers tend to provide applications for free and obtain financial benefits from advertisement or purchase activities using the application. However, as more applications are registered in the application providing apparatus, it becomes more difficult for the application developers to expose their applications to the users and promote the use of the applications. Because of this, the application developers are led to spend more expenses on promoting their applications in an effort to increase the popularity to make users install and use more. Further, the application developers have faced a problem that revenue generation is possible only when applications are installed and used more actively.

### SUMMARY

The following description relates to an application execution terminal, an application providing apparatus, and an application distributing method, which enable an application to be exposed more often to a user using chaining of applications, facilitates the user to search for and execute related applications and provides an application provider with a new revenue source.

In one general aspect, there is provided an application execution terminal comprising: a context information acquiring unit configured to acquire context information of an application being currently executed by a user; a related application recommendation request unit configured to request an application providing apparatus to recommend applications related to the currently executed application while transmitting the acquired context information to the application providing apparatus; and a related application information receiving unit configured to receive information about the related applications from the application providing apparatus in response to the request for the recommendation from the related application recommendation request unit.

In another general aspect, there is provided an application providing apparatus comprising: an application registering unit configured to register an application execution file and a description of an operation of a corresponding application; a related application recommendation request receiving unit configured to receive context information of an application being currently executed in an application execution terminal and a request for recommending applications related to the currently executed application from the application execution terminal; and a related application information providing unit configured to search for applications related to the currently executed application using the context information received through the related application recommendation request receiving unit based on the description of an operation of the application that is registered in the application registering unit and to provide information about the found applications to the application execution terminal.

In another general aspect, there is provided a method for distributing applications of an application providing apparatus, the method comprising: registering an application execution file and a description of an operation of a corresponding application; receiving context information of an application being currently executed in an application execution terminal and a request for recommending applications related to the currently executed application from the application execution terminal; and searching for applications related to the currently executed application using the context information received from the application execution terminal, based on the description of an operation of the application and providing information about the found applications to the application execution terminal.

Other features and aspects will be apparent from the following detailed description, the drawings, and the claims.

### BRIEF DESCRIPTION OF THE DRAWINGS

FIG. 1 is a diagram illustrating an example of an application distribution system.

FIG. 2 is a diagram illustrating an example of an application execution terminal.

FIG. 3 is a diagram illustrating an example of an application providing apparatus.

FIG. 4 is a flowchart illustrating an application distribution process between an application execution terminal and an application providing apparatus.

FIG. 5 is a diagram illustrating an example of descriptions of operations of an application.

FIG. 6 is a diagram illustrating an example of application execution terminals and an application providing apparatus for explaining the chained use of applications related to each other and mutual consignment sales model for the applications.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

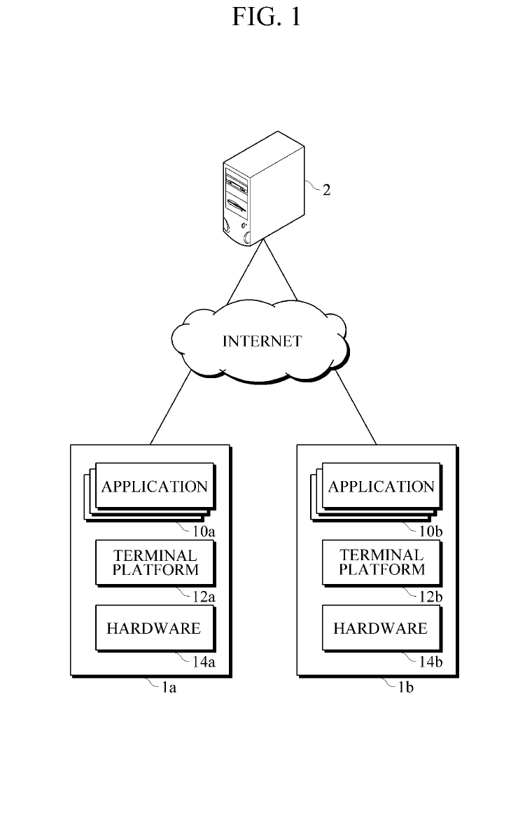

FIG. 1 is a diagram illustrating an example of an application distribution system.

Referring to FIG. 1, the application distribution system includes a plurality of application execution terminals 1a and 1b and an application providing apparatus 2.

The application providing apparatus 2 has a plurality of applications registered therein and enables commerce transactions between application developers and users such that the applications can be provided to the application execution terminals 1a or 1b possessed by the user, for charge or free of charge. The application providing apparatus 2 may be in the form of server that provides the applications to the application execution terminals 1a and 1b through the Internet. Alternatively, the application providing apparatus 2 may be an online space, for example, App Store for iOS operating system (OS) from Apple Inc. or Android Market for Android OS from Google Inc. In this example, the application execution terminals 1a and 1b may be provided with the applications by accessing online the application providing apparatus 2. The application apparatus 2 may manage execution files for the respective applications and description of the relevant operations.

The application execution terminals 1a and 1b may be any types of electronic devices which can download, install and execute an application. For example, examples of the application execution terminals 1a and 1b may include a mobile phone, a personal digital assistant (PDA), a portable multimedia player (PMP), an MP3 player, a digital camera, and so on. Specifically, the application execution terminals 1a and 1b may be multifunctional devices, such as a smartphone, a smart pad, a smart TV, and the like. For convenience of explanation, the example illustrated in FIG. 1 shows only two application execution terminals 1a and 1b (hereinafter, they may be referred to as a “first application execution terminal 1a” and a “second application execution terminal 1b”). However, it should be appreciated that the application execution terminals include all application execution terminals that the user owns.

The application execution terminals 1a and 1b accesses the application providing apparatus 2 over the Internet. The application execution terminals 1a and 1b include terminal platforms, respectively, to support the execution of a number of applications 10a and 10b. The terminal platforms 12a and 12b control hardware 14a and 14b and the execution of the applications 10a and 10b, and each include a library for providing functions, such as graphics, a database and a user interface, which are required for executing the applications 10a and 10b. Generally, the terminal platforms 12a and 12b are called operating systems (OSes) of the first and second application execution terminals 1a and 1b.

The example shown in FIG. 1 assumes that the user owns the first application execution terminal 1a and the second application execution terminal 1b and the user is currently viewing the first application execution terminal 1a, for example, a smart TV.

In one aspect, in response to a request from the first application execution terminal 1a, the application providing apparatus 2 recommends an application related to the application currently running on the first application execution terminal 1a.

The first application execution terminal 1a requests the application providing apparatus 2 to recommend an application related to the currently executed application, and in response, the application providing apparatus 2 may recommend the related application to the user. Association between the related applications may enable to recommend exact applications that the user is interested in and to generate new revenue sources for web developers.

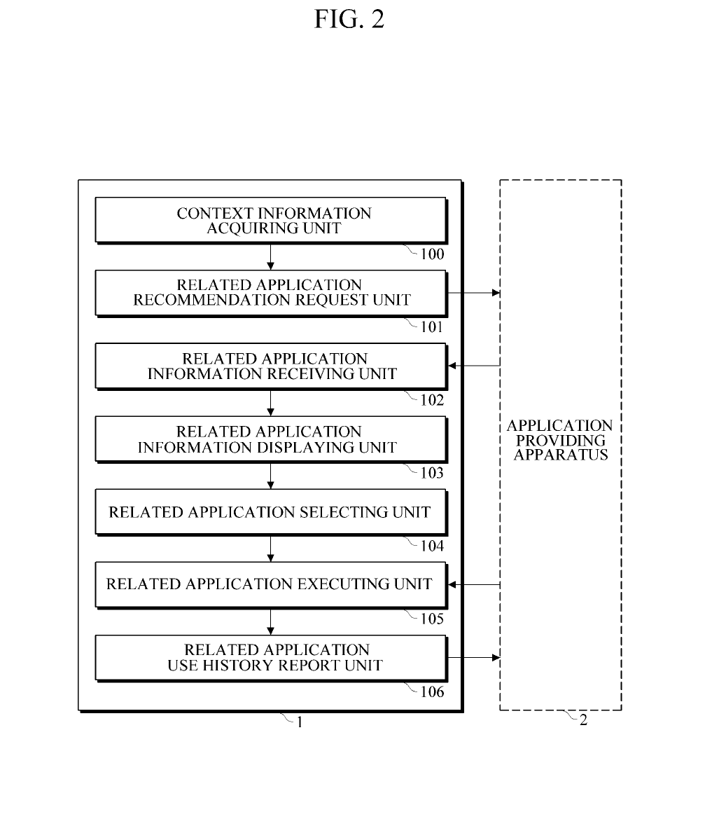

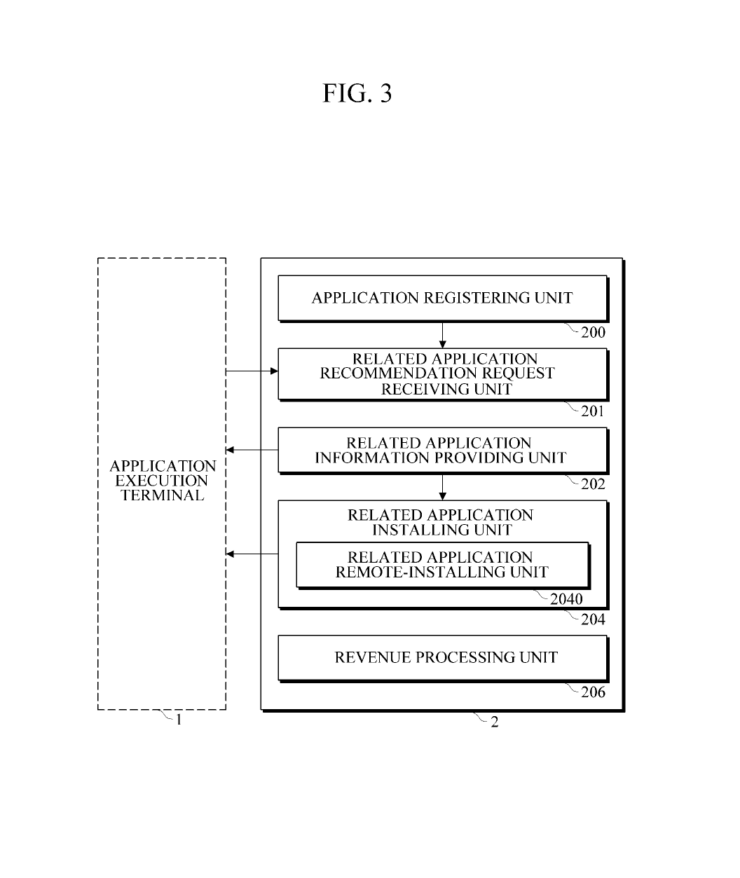

The application providing apparatus 2 may use context information of the application currently being executed by the first application execution terminal 1a so as to recommend a related application that interests the user. In addition, the application providing apparatus 2 may monitor the chained use of related applications and purchase history of the related applications which are derived from advertisement exposed by the applications and mutual consignment sales of the related applications for the purpose of settlement and distribution of the revenues generated from the exposure of the related applications. In addition to the monitoring, the application providing apparatus 2 enables to provide a service utilizing the first application execution terminal 1a and the second application execution terminal 1b which are possessed by the user by remotely installing and executing the related application in the second application execution terminal 1b. The chained use of the related applications and the mutual consignment sales of the related applications are rendered by an interworking between the first and second application terminals 1a and 1b and the application providing apparatus 2. Configurations of the first and second application execution terminals 1a and 1b and the application providing apparatus 2 will be described in detail with reference to FIGS. 2 and 3.

FIG. 2 is a diagram illustrating an example of an application execution terminal.

Referring to FIG. 2, the application execution terminal 1 includes a context information acquiring unit 100, a related application recommendation request unit 101, and a related application information receiving unit 102, and may further include a related application information displaying unit 103, a related application selection unit 104, a related application execution unit 105, and a related application use history report unit 106.

The context information acquiring unit 100 acquires context information about an application being currently executed by the application execution terminal 1. The application to be executed is selected according to the user's need, and the selected application enters a running state in the application execution terminal 1.

The context information acquired by the context information acquiring unit 100 is used to receive recommendations for applications related to the currently executed application from the application providing apparatus 2. If the currently executed application is a social network service, for example, KaKaoTalk®, the context information may include information about a displayed user name and chatting conversation history. If the currently executed application is a location-based service application, the context information may be current location information.

According to one aspect, the context information acquiring unit 100 may acquire internal context information of the application being currently executed as well as the application's identifier. The application's internal context information is information, such as input data, output data, and a variable value, which reflects a current state of the executed application.

As one example, the context information acquiring unit 100 issues a request and acquires the internal context information of the currently executed application. As another example, the context information acquiring unit 100 extracts the application internal context information from values of user interface components that are displayed on a display screen of the context information acquiring unit 100. In the later example, there is no need for further development of functions in an application, but it may be difficult to extract accurate context information. In the former example, since the application can decide which information is to be provided, it is possible to extract accurate context information, whereas the application developer may be required to further develop additional functions.

By utilizing the application internal context information, it is possible to provide a recommendation for a related application based on input/output data of the application and also by reflecting the current user state according to the input/output data. For example, in the case of an application for outputting location information, a general location-based application, such as a map application, may be recommended if there is no application internal context information. However, if location information, for example, Seoul, is provided as application internal context information, a more specific application, such as Seoul bus transit guide, may be recommended.

The related application recommendation request unit 101 requests the application providing apparatus 2 to recommend applications related to the currently executed application while transmitting the application context information acquired by the context information acquiring unit 100 to the application providing apparatus 2. At this time, the application being currently executed becomes a source application for the related applications. In addition, if the user requests to recommend a different related application while one of the already-recommended related applications is being executed, the related application being currently executed becomes a source application for the different recommended related application. That is, it should be appreciated that any application can be a source application for other applications.

The related application recommendation request unit 101 requests the application providing apparatus 2 to recommend applications related to the currently executed application by use of a predefined user interface, such as a touch screen, a remote control, and the like. In addition, the related application recommendation request unit 101 transfers the context information of the currently executed application, along with the request for recommending the related applications, to the application providing apparatus 2. The context information of the currently executed application is information, such as input data, output data, and a variable value, which reflects a current state of the executed application.

The application providing apparatus 2 searches for the applications related to the currently executed application based on the application context information, and the related application information receiving unit 102 receives the information about the found applications from the application providing apparatus 2.

The related application information display unit 103 displays the information about the related applications that is received through the related application information receiving unit 102. The related application information may be in the form of a list.

In one example, the related application information display unit 103 separately displays information of the related application being previously installed in the application execution terminal 1 and information of a related application to be further installed. In another example, the related application information display unit 103 displays information about related applications executable in the application execution terminal 1 and information about related applications executable in another application execution terminal owned by the user.

The user uses the related application selecting unit 104 to select a predetermined application using the information about the related applications that is displayed on the related application information display unit 103. For example, the user selects one from a related application list displayed by the application execution terminal 1.

The related application executing unit 105 executes the selected related application, or executes a related application provided from the application providing apparatus 2. For example, for the instant installation of the selected related application, the related application executing unit 105 downloads the corresponding related application from the application providing apparatus 2 and installs and executes the downloaded application. The installation process follows the installation procedure specified by a platform of the application execution terminal 1, and if an application to be installed is a paid application, the payment procedure normally proceeds along with the installation and the purchase of the paid application is notified to the application providing apparatus 2. If the selected related application has already been installed in the application execution terminal 1, the installation may be omitted.

The related application use history report unit 106 reports the use of the selected related application and advertisement exposure and history of purchases which are derived from the use of the selected related application to the application providing apparatus 2. For example, the selected related application may expose an advertisement introduced by an application developer while being executed, and there may occur a purchase activity through the selected application if the application has an e-commerce function. The related application use history report unit 106 reports the aforementioned advertisement exposure or purchase activities of the user to the application providing apparatus 2.

FIG. 3 is a diagram illustrating an example of an application providing apparatus.

Referring to FIG. 3, the application providing apparatus 3 includes an application registering unit 200, a related application recommendation request receiving unit 201 and a related application information providing unit 202, and may further include a related application installing unit 204 and a revenue processing unit 206.

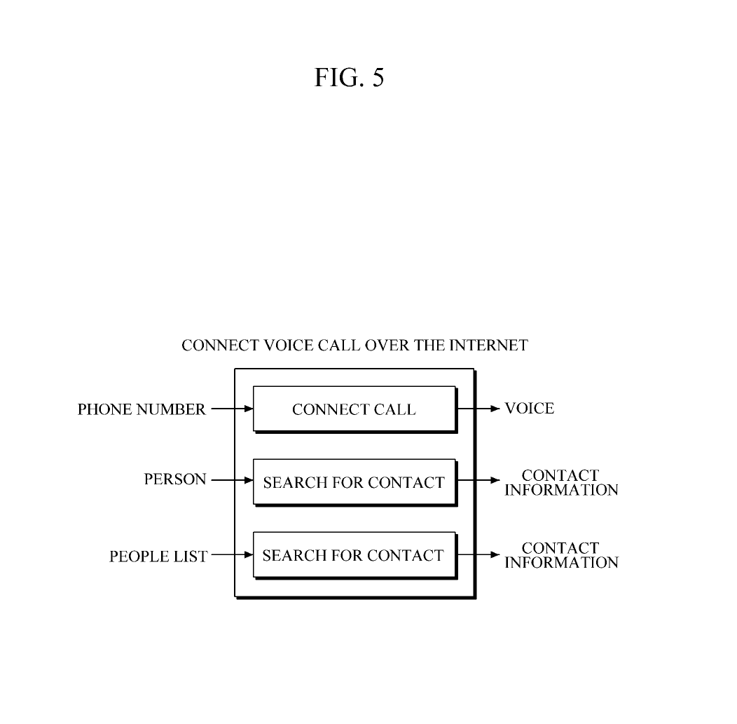

An application developer uses the application registering unit 200 to register an application execution file and description of an operation of the application. The description of an operation of the application may be provided in various formats. For example, the specification may be free-form sentence that describes the functionality of the application, for example, “Connect voice call over the Internet.” For another example, the specification may describe input/output properties and functionality of the application using a grammar structured as XML and a dictionary previously defined. It may be desirable to utilize both specification formats so as to provide information understandable to the user and to achieve mechanized processing of the information. The description of an operation of the application will be described in detail later with reference to FIG. 5.

The related application recommendation request receiving unit 201 receives a request for applications related to an application being currently executed in an application execution terminal 1 and context information of the currently executed application from the application execution terminal 1. The application context information may include application internal context information, such as input data, output data, and a variable value, which reflects a current state of the executed application.

The related application information providing unit 202 searches for the applications related to the currently executed application using the application context information received by the related application recommendation request receiving unit 201 based on the description of an operation of the application registered in the application registering unit 200, and provides information about the found application to the application execution terminal 1.

In one example, the related application information providing unit 202 provides not only information about the application executable in the application execution terminal 1 but also information about an application executable in a different application execution terminal owned by the user. That is, the information provided by the related application information providing unit 202 to the application execution terminal 1 is not limited to the information about the application executed in one application execution terminal, and may include all information about applications executed in any application execution terminals owned by the user. For example, if the user owns a smart TV, a smart phone and a tablet PC, the application providing apparatus 2 may provide information about applications executable in the smart phone and/or table PC, along with an application relating to the smart TV, in response to a request for a recommendation for the related application for the smart TV that the user is watching.

In response to the information about the related applications being received from the related application information providing unit 202, the user of the application execution terminal 1 may request the application providing apparatus 2 to provide a desired application based on the received information. The related application installing unit 204 may install the related application requested by the user in the application execution terminal 1.

In one example, the related application installing unit 204 includes a related application remote-installing unit 2040. In response to a request for a related application executable in a different application execution terminal from the application execution terminal 1, the related application remote-installing unit 2040 installs the application in the other application execution terminal remotely. For example, in a case in which the user owns a smart TV, a smartphone and a tablet PC, the related application information providing unit 202 recommends an application related to the smart TV as well as other applications executable in the smartphone and/or the table PC in response to the request for a recommendation for the related application for the smart TV. In this example, if the user selects an application for the smartphone, the related application remote-installing unit 2040 may remotely install the selected application in the smartphone.

The revenue processing unit 206 manages revenue generated from the installation of the application and the use of the related application including advertisement exposure, and distributes the revenue according to the applications. For example, the revenue processing unit 206 may calculate revenues generated from the installation of the related application and the advertisement exposure at a predetermined time or periodically at a fixed interval, and provides a source application that contributes to revenue generation with a share of revenues according to a predefined sharing ratio. The applications of the revenue account processing unit 206 to a distribution system in an effort to distribute revenues derived from related applications may enable to automatically form a mutual consignment sales model for all the applications.

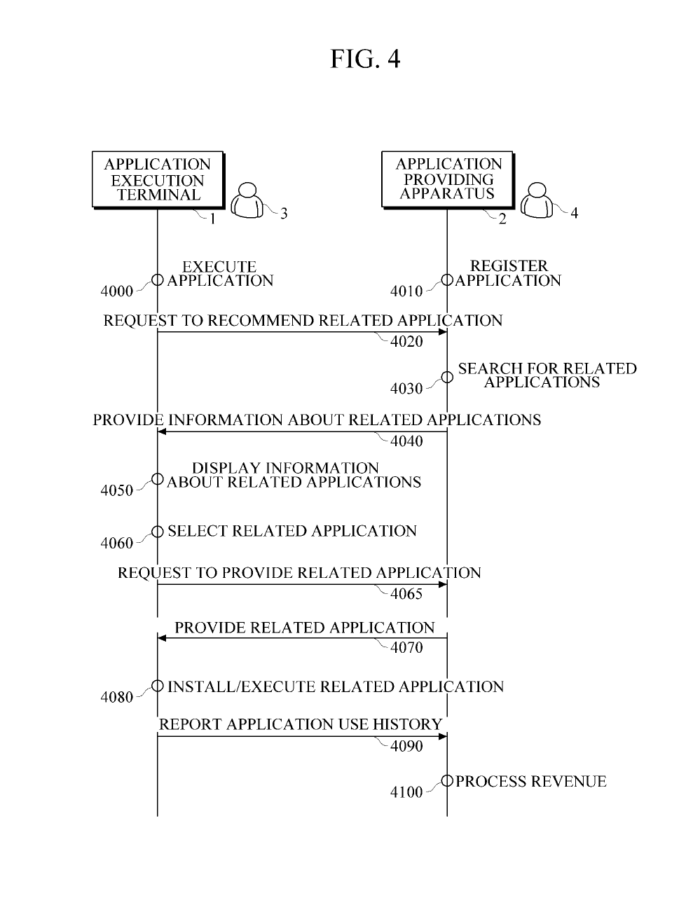

FIG. 4 is a flowchart illustrating an application distribution process between an application execution terminal and an application providing apparatus.

Referring to FIG. 4, an application developer 4 registers an application execution file and a description of an operation of the application in 4010. The user 3 executes the application using the application execution terminal 1 in 4000.

Then, the user 3 transmits a request for a recommendation for an application related to the application being currently executed in the application execution terminal 1, along with the context information of the application in 4020.

In response to the request from the user 3, the application providing apparatus 2 searches for applications related to the currently executed application using the context information received from the application execution terminal 1 based on the description of an operation of the application in 4030, and provides information about the found applications to the application execution terminal 1 in 4040.

Thereafter, the application providing apparatus 2 displays the information about the related applications on a display screen in 4050. At this time, the application providing apparatus 2 displays information about the related application executable in the application execution terminal 1 and information about other related applications that are executable in other application execution terminals owned by the user.

The user 3 selects a predetermined related application using the information about the related applications in 4060. In response to a request for the application selected by the user 3 from the application execution terminal 1 in 4065, the application providing apparatus 2 provides the requested application to the application execution terminal 1 in 4070. Then, the application execution terminal 1 installs and/or executes the application provided from the application providing apparatus 1 in 4080.

Further, the application execution terminal 1 reports revenues generated from the installation and execution of the related application and the use of the relate application including advertisement exposure to the application providing apparatus 2 in 4090. Accordingly, the application providing apparatus 2 manages the revenues derived from the use of the related application and distributes the revenues according to the applications in 4100.

FIG. 5 is a diagram illustrating an example of descriptions of operations of an application.

Referring to FIGS. 3 and 5, an application developer uses the application registering unit 200 to register an application execution file and description of an operation of the application. The description of an operation of the application may be provided in various formats, and for example, it may be provided as a free-form sentence, such as “Connect voice call over the Internet,” which describes functionality of the application. In addition, depending on functions of each application, properties of input data, properties of output data and functions may be additionally provided in conformity with a predefined grammar.

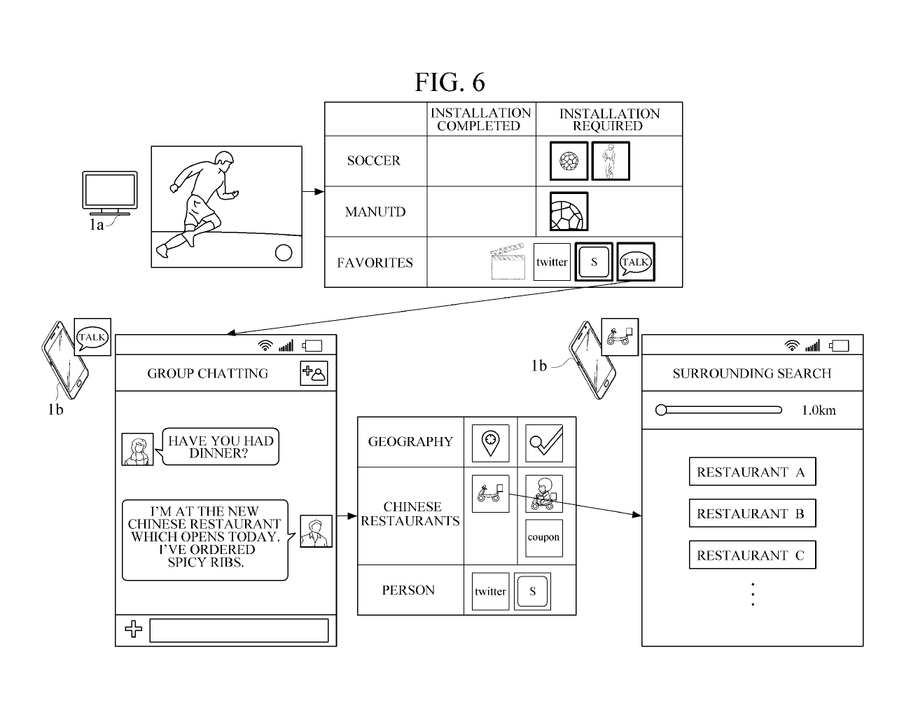

FIG. 6 is a diagram illustrating an example of application execution terminals and an application providing apparatus for explaining the chained use of applications related to each other and mutual consignment sales of the applications.

Referring to FIGS. 1 and 6, the example assumes that a user owns the first application execution terminal 1a, that is a smart TV, and the second application execution terminal 1b, that is a smartphone, and the user is watching a soccer game through the application execution terminal 1a by executing a broadcast information application. In this example, the user uses a predetermined user interface, such as a remote control, to request the application providing apparatus 2 to recommend an application related to the application being currently executed in the first application execution terminal 1a.

To request the recommendation for a related application, the first application execution terminal 1a acquires context information of the broadcast information application after confirming that the broadcast information application is being executed. For example, the first application execution terminal 1a may acquire application internal context information that, for example, the user is watching a game “UEFA Champions League <MANUTD vs. Marseille> on a sport channel. Then, the first application execution terminal 1a requests the application providing apparatus 2 to recommend the related applications and simultaneously transmits an identifier of the currently executed application and the application internal context information.

Thereafter, the application providing apparatus 2 recommends the related applications to the first application execution terminal 1a using the context information transmitted from the first application execution terminal 1a. The recommendation for the related application may be performed based on the context information and description of an operation of the currently executed application received from the first application execution terminal 1a or by utilizing mash-up algorithms. For example, the application providing apparatus 2 extracts information of “soccer” and “MANUTD” from the context information and recommends an application relating to the extracted information to the first application execution terminal 1a.

A list of the recommended applications may be displayed on the first application execution terminal 1a. In this case, among the recommended applications, the applications that have been already installed in the first application execution terminal 1a and the applications to be newly installed are separately displayed. In addition, information about an application executable in the second application execution terminal 1b not in the first application execution terminal 1a can also be displayed. As shown in FIG. 6, the application executable in the second application execution terminal 1b may be differently displayed by changing a shape of edges or color of the displayed image of the application. Furthermore, favorite applications registered by the user may be displayed together, and when the user searches the list of related applications, functions and prices of each application may be displayed as well.

In response to a predetermined related application being selected by the user from the list, the selected application is installed and/or executed. In the example illustrated in FIG. 6, the user selects a group chatting application from favorite list, wherein the group chapping application has already been installed in the second application execution terminal 1b. The second application execution terminal 1b executes the selected group chatting application, and the user can have chatting conversations through the second application execution terminal 1b while watching the soccer game using the first application execution terminal 1a.

Furthermore, if the user requests the application providing apparatus 2 to recommend an application related to the group chatting application while having chatting conversations through the second application execution terminal 1b, the chatting conversations delivered through the group chatting application are transmitted to the application providing apparatus 2 as application internal context information. For example, as application internal context information, “Chinese restaurant” may be transmitted.

Then, the application providing apparatus 2 recommends the related applications, for example, an application related to a Chinese restaurant and/or a person, based on the received context information, and a list of the related applications is displayed on the second application execution terminal 1b.

If the user selects to execute a food delivery order application, internal context information of the first application may be transferred to the executed food delivery order application to help the user to choose food, and revenue is generated from the food delivery order application when the user orders through the food delivery order application. The chained use of the broadcast information application, group chatting application and the food delivery order application and relevant revenue generation are reported to the application providing apparatus 2 by use of functions of exposing advertisements and purchase support of the application execution terminals 1a and 1b. Finally, the application providing apparatus 2 distributes shares of revenues generated from the food delivery order application, based on the received report of the use and the revenue, to the contributing group chatting application and broadcast information application.

As described above, the application providing apparatus and the application execution terminal enable to expose an application more often to a user using chaining of applications, facilitate the user to search for and execute related applications and provide an application provider with a new revenue source.

According to a conventional application distribution method, a user needs to directly search for a required application or receives a recommendation for a sale/download application from an application providing apparatus and installs the recommended application. According to the above examples of the present invention, a user is recommended for applications related to an application being currently executed in the application execution terminal by the application providing apparatus, and installs the recommended application. In addition, a structure of profit sharing of revenues generated from the use of the related application is supported in terms of a distribution system, and thus automatically mutual consignment sales model is established for all applications.

In addition, because the user is recommended for applications closely related to a current application in use, it is possible to promote the installation and use of applications. Moreover, according to the above examples, the application can be easily exposed to the user without an additional public relations (PR) process, and thus the application developer can easily enter the market. Furthermore, the application developer shares in the revenues generated from related applications, and thus stable profitability can be ensured. Further, a terminal platform supplier and an application providing apparatus operator are provided with more convenience in using applications and more chances of revenue generation, so that the application ecosystem can be activated.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An application execution terminal comprising:
a context information acquiring unit configured to acquire context information of an application being currently executed by a user;
a related application recommendation request unit configured to request an application providing apparatus to recommend applications related to the currently executed application while transmitting the acquired context information to the application providing apparatus; and
a related application information receiving unit configured to receive information about the related applications from the application providing apparatus in response to the request for the recommendation from the related application recommendation request unit.

2. The application execution terminal of claim 1, wherein the context information acquiring unit is configured to acquire internal context information of the currently executed application along with an identifier of the currently executed application, and the internal context information is information which reflects a current state of the executed application using input data, output data and variable values.

3. The application execution terminal of claim 2, wherein the context information acquiring unit is configured to acquire the internal context information by requesting the currently executed application.

4. The application execution terminal of claim 2, wherein the context information acquiring unit is configured to extract the internal context information from a value of a user interface component displayed on a display screen.

5. The application execution terminal of claim 1, further comprising:
a related application information displaying unit configured to display the information about the related applications that is received through the related application information receiving unit.

6. The application execution terminal of claim 5, wherein the related application information displaying unit is configured to separately display the information about the related applications having already been installed in the application execution terminal and the information about the related applications to be newly installed.

7. The application execution terminal of claim 5, wherein the related application information displaying unit is configured to display the information about the related applications executable in the application execution terminal and the information about the related applications executable in a different application execution terminal owned by the user.

8. The application execution terminal of claim 5, further comprising:
a related application selecting unit configured to enable the user to select a predetermined application using the information about the related applications that is displayed on the related application information displaying unit; and
a related application executing unit configured to execute the related application selected by the user through the related application selecting unit or to be provided with the selected application from the application providing apparatus and execute the provided application.

9. The application execution terminal of claim 8, further comprising:
a related application use history report unit configured to report use of the related application selected by the user through the related application selecting unit, relevant advertisement exposure and history of purchases to the application providing apparatus.

10. An application providing apparatus comprising:
an application registering unit configured to register an application execution file and a description of an operation of a corresponding application;
a related application recommendation request receiving unit configured to receive context information of an application being currently executed in an application execution terminal and a request for recommending applications related to the currently executed application from the application execution terminal; and
a related application information providing unit configured to search for applications related to the currently executed application using the context information received through the related application recommendation request receiving unit based on the description of an operation of the application that is registered in the application registering unit and to provide information about the found applications to the application execution terminal.

11. The application providing apparatus of claim 10, further comprising:
a related application installing unit configured to, in response to a request from the application execution terminal to provide a predetermined related application according to the information about the related applications provided from the related application information providing unit, install the requested application in the application execution terminal.

12. The application providing apparatus of claim 11, wherein the related application installing unit is configured to, in response to a request from the application execution terminal to provide the related application that is executable in a different application execution terminal owned by a user, remotely install the requested application in the other application execution terminal.

13. The application providing apparatus of claim 10, wherein the related application recommendation request receiving unit is configured to, when the related application provided by the related application information providing unit is executed in a different application execution terminal owned by a user, receive a request from the different application execution terminal for recommending another application related to the application being executed in the different application execution terminal, and the related application information providing unit is configured to search for other applications related to the related application and to provide information about the found applications to the different application execution terminal.

14. The application providing apparatus of claim 10, further comprising:
a revenue processing unit configured to manage revenues generated from installation and execution of the related application and use of the related application including advertisement exposure and to distribute the revenues according to the related applications.

15. The application providing apparatus of claim 14, wherein the revenue processing unit is configured to distribute a share of the revenues generated from the use of the related applications to an application that is a source of the related applications.

16. A method for distributing applications of an application providing apparatus, the method comprising:
registering an application execution file and a description of an operation of a corresponding application;
receiving context information of an application being currently executed in an application execution terminal and a request for recommending applications related to the currently executed application from the application execution terminal; and
searching for applications related to the currently executed application using the context information received from the application execution terminal, based on the description of an operation of the application and providing information about the found applications to the application execution terminal.

17. The method of claim 16, wherein the providing of the information about the related applications to the application execution terminal comprises providing the information about the related applications executable in the application execution terminal and the information about the related applications executable in a different application execution terminal owned by the user.

18. The method of claim 17, further comprising:
when the related application is executed in a different application execution terminal owned by a user according to the provided information about the related application, receiving a request from the different application execution terminal for recommending another application related to the application being executed in the different application execution terminal, and
searching for other applications related to the related application and to provide information about the found applications to the different application execution terminal.

19. The method of claim 17, further comprising:
in response to a request from the application execution terminal to provide a predetermined related application according to the information about the related applications provided, installing the requested application in the application execution terminal, and
if necessary, in response to a request from the application execution terminal to provide the related application that is executable in the different application execution terminal owned by the user, remotely installing the requested application in the other application execution terminal.

20. The method of claim 19, further comprising:
managing revenues generated from installation and execution of the related application and use of the related application including advertisement exposure and distributing the revenues according to the related applications.
